(19) United States
(12) Patent Application Publication
(10) Pub. No.: US 2003/0009360 A1
(43) Pub. Date: Jan. 9, 2003

(54) System and process for providing better car service from car services companies

(76) Inventors: Shafquat Chaudhary, Bayville, NY (US); Salah Chaudhry, White Plains, NY (US)

Correspondence Address: COLLARD & ROE, P.C., 1077 Northern Boulevard, Roslyn, NY, 11576-1696, US

(21) Appl. No.: 10/156,623

(22) Filed: May 28, 2002

Related U.S. Application Data
(60) Provisional application No. 60/293,876, filed on May 25, 2001.

(51) Int. Cl. G06F 17/60

(52) U.S. Cl. 705/5

(57) ABSTRACT

A computerized process and system for selecting a vehicle for transport comprising a series of steps. This process includes selecting a departure location, and selecting a destination location. The process also includes a step for selecting a preferred carrier, wherein once the preferred carrier has been selected, the computer network determines whether the preferred carrier is available. This process also includes a step for selecting at least one additional carrier if the preferred carrier is not available. In one embodiment this step can occur automatically with a computer determining the appropriate carrier based upon availability, price, and quality of service. In another embodiment of the invention, the preferred carrier can refer the user to the additional carrier for a referral fee. Next, the additional carrier is presented to a user wherein the reservation is processed.

### REFERENCE TO RELATED APPLICATIONS

This application is based on U.S. Provisional Application Serial No. 60/293,876 filed on May 25, 2001 and wherein priority is claimed under 35 U.S.C. §119(e).

### BACKGROUND

The invention relates to a system and a process for improving a car service by automating a scheduling and referral service. Car service providers have in the past had trouble providing all of the service for their customers. Some car service companies only provide car service in a localized region. Other car service companies have limited resources so that they may not be able to meet their client's needs during particularly busy times. To provide better service to customers, car service companies would like to refer business to other car service companies that are either located in a different geographic location or who are located in an overlapping or adjacent geographic location but have excess capacity to provide service during especially busy times.

### SUMMARY

The present invention relates to a system and a process for providing referrals to one of a plurality of car service companies from either a centralized location or another car service company. These referrals are useful because many users would otherwise not be able to receive service from that first car service company because the pickup or arrival locations are outside of the car service company's field of service. In addition, that car service company may not have enough available drivers or cars for that service at that time. Therefore this first car service company would need to send a referral to a second car service company.

There is also a quality rating system that includes a remote terminal such as a wireless touch screen inside of a car or a remote computer terminal that allows the user to input quality service information. This quality service information is then forwarded on to a server that stores and processes this information.

In addition, there is also a system and a process for facilitating the pickup of users or passengers from a particularly busy site. This site may be an airport, a stadium, a bus or train depot or a large office building. The system includes a central computer or server, and a concierge which is in contact with a remote terminal such as a hand held wireless terminal. This remote terminal allows the concierge to keep in communication with the central computer. The central computer can then signal to the concierge of a future event occurring such as a plane landing, a concert ending, a train or bus arriving, or a meeting ending. The concierge may receive this signal up to 15 minutes before this event ends. Next, the concierge confirms that this event occurs and then, signals to have the nearest car dispatched to service any customers or users associated with that event. This central computer keeps in constant contact with each of the cars in the car service company wirelessly via GPS tracking and through cellular communication. Via this wireless GPS tracking, the centralized computer determines the car closest to the concierge and signals that car to approach the concierge. Once the car arrives, the concierge directs the user to enter the car. Once that car has been delivered, the next closest car moves up in the line to deliver service to the next customer or user.

In addition, this invention also includes a system and a process for referring additional drivers and then organizing these drivers into a series of teams. Each team has a team leader. There is also a section leader that can supervise up to five team leaders. A group manager supervises up to four section managers. Each team leader receives a payment plus a management bonus. The section leader receives a commission for each driver in that section and there is also a management bonus.

The group manager receives a commission each week for each driver in the group. There is a management bonus which has a potential greater than that of the section leader.

### BRIEF DESCRIPTION OF THE DRAWINGS

Other objects and features of the present invention will become apparent from the following detailed description considered in connection with the accompanying drawings which disclose several embodiments of the present invention. It should be understood, however, that the drawings are designed for the purpose of illustration only and not as a definition of the limits of the invention.

In the drawings wherein similar reference characters denote similar elements throughout the several views:

FIG. 1A is a schematic block diagram of a computer network;

FIG. 1B is a schematic block diagram for a computer network involving wireless components;

FIG. 2 is a flow chart showing a first process for referring one user from a first car service company to a second car service company;

FIG. 3 is a flow chart showing a second process for referring one user from a first car service company to a second car service company;

FIG. 4 is a flow chart showing a process for determining the quality of a car service company;

FIG. 5 is a flow chart showing a process for wirelessly communicating with personnel to organize a car service company at a particular site;

FIG. 6 is a flow chart showing a process for arranging drivers in a management team; and

FIG. 7 is an organizational chart showing the arrangement of drivers in a management team.

### DESCRIPTION

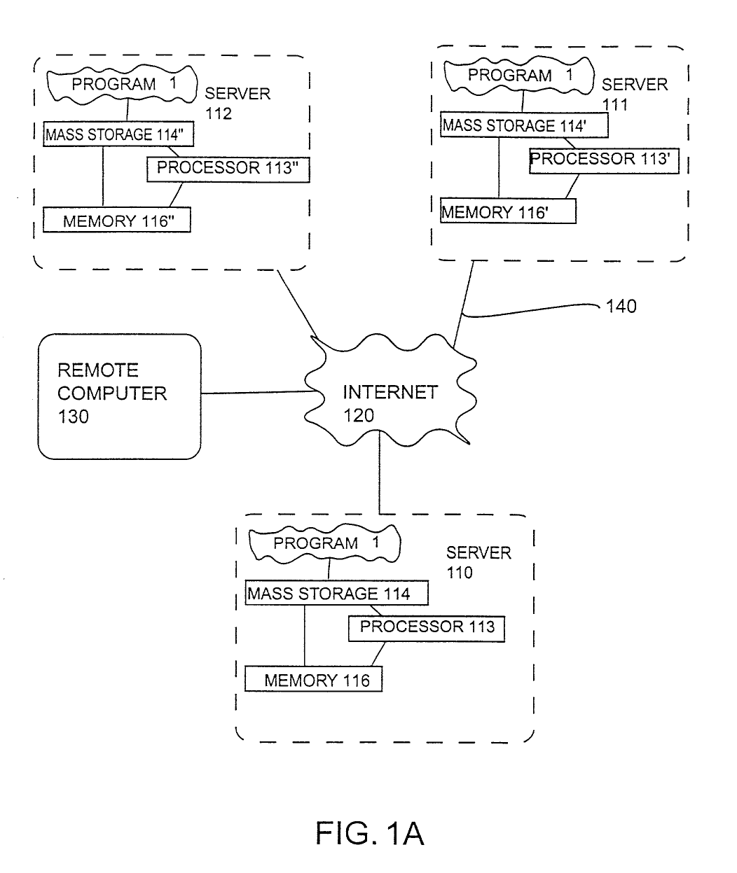

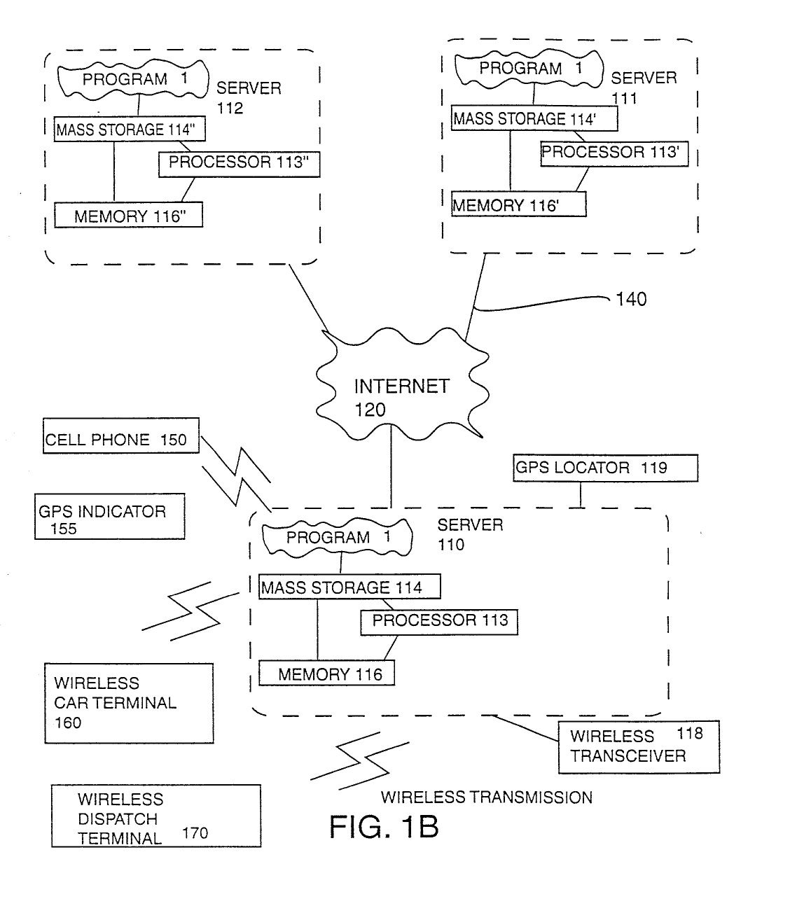

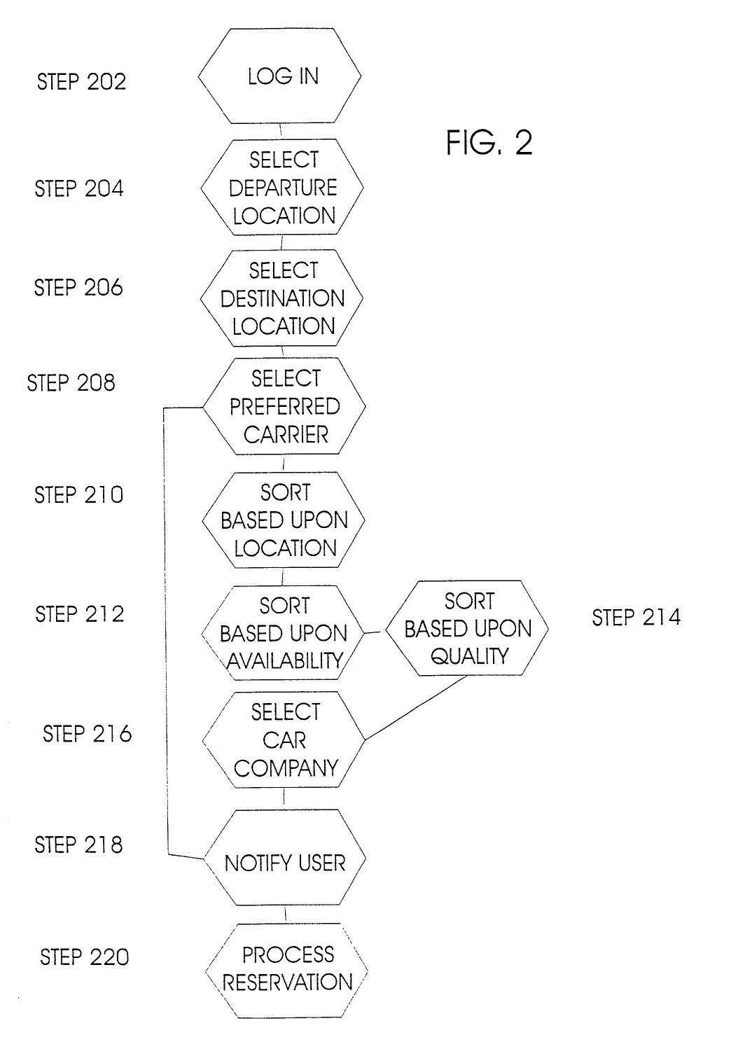

FIG. 1A is a schematic block diagram of the computer network. As shown in FIG. 1A, there are a series of servers 110, 111, and 112 in communication with each other through the internet 120 either wirelessly or through communication lines 140. There is also at least one remote computer 130 in communication with internet 120. Servers 110, 111, and 112 all run program 1 using processors 113, 113′ and 113″ respectively. These processors could be made from the Intel Corporation, AMD or any other type corporation that makes processors for computers. In addition, servers 110, 111, and 112 all have mass storage units 114, 114′ and 114″ and memory units 116, 116′, and 116″ respectively. Mass storage units could be in the form of hard drives, flash memory or any other type of mass storage known in the art. The memory units could be in the form of RAM which relays and stores information sent between the mass storage units and the processors. Program 1 running on these processors essentially functions as a system host that allows these servers 110, 111, and 112 to process information and perform a series of steps shown in FIGS. 2-5.

FIG. 1B shows a variation on FIG. 1A in that this embodiment supports wireless communication by using a wireless transceiver 118 disposed in server 110. Wireless transceiver 118 is in communication with cell phones 150, a wireless car terminal 160 and a wireless dispatch terminal 170. Users such as customers can use their cell phones to dial into server 110 and then wirelessly schedule a reservation. In addition, server 110 can receive and send calls to car drivers associated with a participating car service company from wireless transceiver 118 to cell phones 150. Furthermore, users such as customers can enter information into wireless car terminals 160. These wireless car terminals are used to enter service quality information into server 110. Finally a concierge that is working with a participating car service company that is located at a remote site can keep in touch with information stored on server 110 via a wireless dispatch terminal 170. Both the wireless car terminal 160 and the wireless dispatch terminal can be in the form of a touch screen or portable computer that allows users to enter and send information or receive and view information on that terminal. There is also a GPS locator 119 that allows server 110 to consistently locate a driver and determine the location of that driver. The driver would correspondingly have a GPS indicator 155 which allows the GPS locator 119 to locate the position of the driver.

FIG. 2 is a flow chart showing a first process for referring one user from a first car service company to a second car service company. In step 202, a user logs in to the system. In this case the user is a person who is looking to reserve a car service. Once the user has logged into one of the servers above, in step 204, the user selects a departure location through a web page. Next, in step 206 the user selects a destination location. In step 208 the user selects a preferred carrier such as a particular type of car service company. In step 210 the system host which controls server 110, 111 or server 112 sorts through a list of car service companies based upon the location of service provided by that car service company. This type of sorting can be based upon the zip code or geographic region that is serviced by the car service company. Next, in step 212 the system host sorts through the car service companies based upon the availability of these car service companies.

For example, some car service companies may have limited resources and a high call volume. Therefore, these car service companies may not have cars available to provide convenient fast service to these users. Therefore, the system host would determine whether a car service company in that geographic location has cars that are available to provide this service. In this system, the system host would be continuously receiving information regarding the availability of service from these car service companies. Each of the car service companies would have a dispatcher or dispatch computer that updates the system host as to the availability of that car service companies' cars.

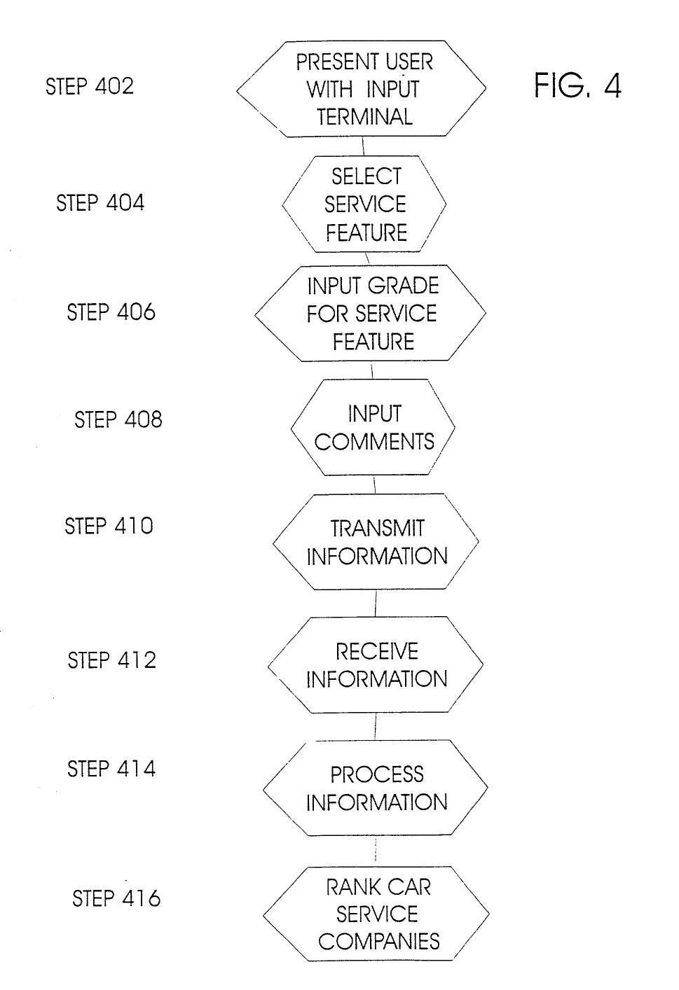

Next, in step 214, the system host reviews each of the available car service companies based upon the quality of service delivered by that car service company. The process for this review is shown in greater detail in FIG. 4. In step 216 the system host selects a particular car service company for service. Next, in step 218, the system host notifies the user of the selected car service company. If the user does not want to use that particular car service company, then the user could start the process back at step 208 wherein the user selects his or her own preferred carrier.

Next, in step 220 the system host processes this reservation by taking the billing information of the user and sending the user a receipt.

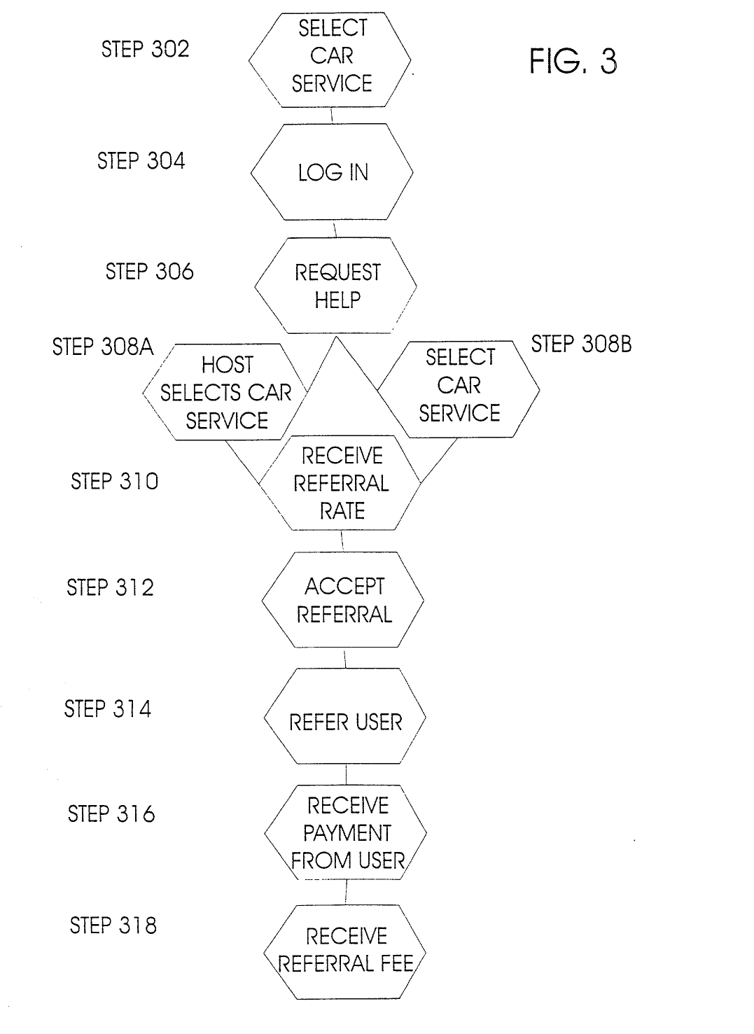

FIG. 3 is a flow chart showing a second process for referring one user from a first car service company to a second car service company. For example in this system, in step 302 a user would select a particular car service company either through a website or by directly calling that car service company. If the car service company could not provide that service, then the car service company would log into the system host in step 304 and then request assistance in providing car service to that user in step 306.

Next in step 308 which includes steps 308A, and 308B, the system host in step 308A can select a car service company for the first car service company. Alternatively, in step 308B, the system host would present a list of car service companies to present to the user. In this step, that first car service company would select the car service company that would provide the service. Next, in step 310, the system host presents the first car service company with the referral rate for referring this service to the second car service company. If in step 312, the first car service company accepts this referral, then in step 314, the first car service company refers this user to the second car service company. In step 316, either the system host, the first car service company, or the second car service company receives a payment from the user. Next, in step 318, the referral fee is deducted from this payment and presented to the first car service company.

FIG. 4 is a flow chart showing a process for determining the quality of a car service company. With this process, a user can input service quality information to describe the quality of the service presented by a car service company. In step 402, the user is presented with an input terminal. The input terminal can be a wireless terminal 160 shown in FIG. 1B disposed within a car or a web page on a screen associated with a personal computer 130 shown in FIG. 1A. Next, in step 404, the user selects a certain characteristic for the service provided by the car service company. For example, these types of characteristics are: timeliness such as whether the car service arrived on time and delivered the user on time; cleanliness of the car; or the disposition of the driver such as how the driver treated the user. In step 406, The user then rates the quality of these characteristics based upon a preset scale such as a scale from 1 to 5 with 1 being the worst quality Ad service and 5 being the best quality service. In step 408, the user can then input his or her personalized comments such to give a greater indication of the quality of the service or to explain the rating on one of the characteristics. Next, in step 410 this information is transmitted to the system host on servers 110, 111, or 112. If the input terminal is a wireless device then this information is sent wirelessly to the system host. The system host receives this information in step 412 and then processes this information in step 414. Next, in step 416 the system host ranks each car service company based upon the quality of service provided by each car service company.

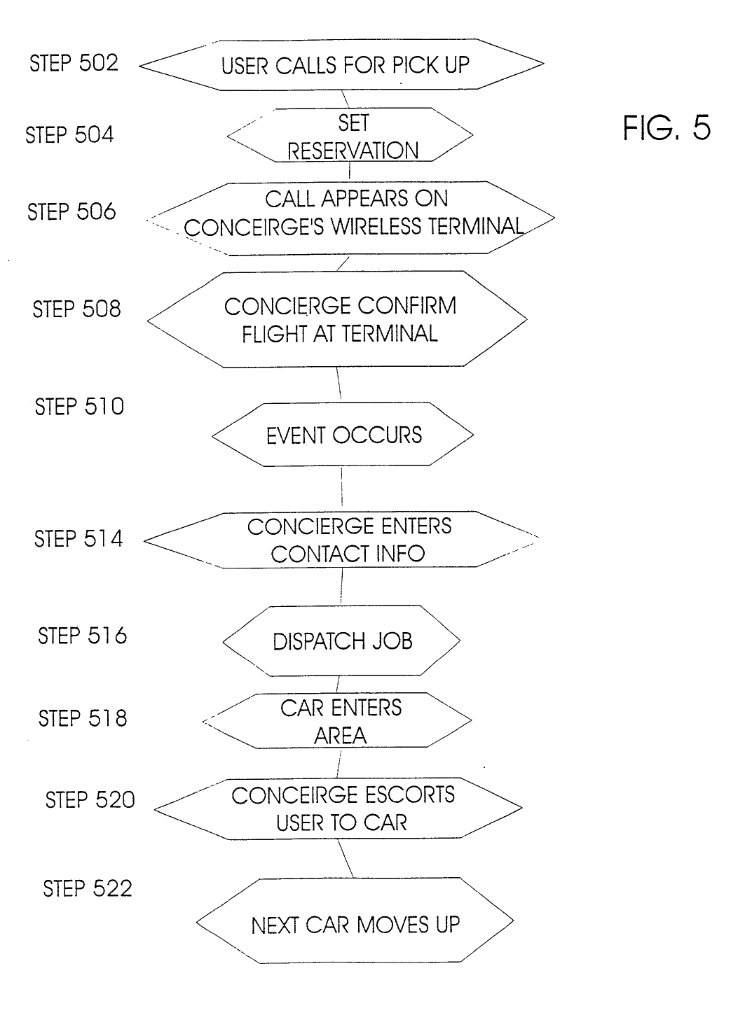

FIG. 5 is a flow chart showing a process for wirelessly communicating with personnel to organize a car service company at a particular site. These sites may be particularly busy sites such as airports, train or bust depots large office buildings, or stadiums that experience heavy car service volume from users. Thus car service companies would then place a concierge person on that site to organize the car service for each user.

In step 502 a user calls for a pick up from a car service company. In step 504 the system host sets a reservation for that user. In step 506, a call appears on that concierge's wireless terminal. This call usually occurs 15 minutes before the event occurs. Next, in step 508, the concierge confirms a particular event at that location. Next, in step 510 this event occurs. This event could be the arrival of a flight, the arrival of a bus or train, or the ending of a game or concert at a stadium. Once this event has been confirmed, in step 514, the concierge enters contact information into the remote terminal so that in step 516, a car service job is dispatched. In this case, the system host operating on server 110 would determine the position of the car closest to the concierge. This would be accomplished by having GPS locator 119 contact a GPS indicator 155 disposed each of the driver's cars. The car closest to the concierge would then be selected for dispatch. Once this car service job has been dispatched, a car associated with that car service company is notified. In step 518, the car enters the area. In step 520 the concierge escorts the user to the car. Once this job has been completed, in step 522 the next closest car to the concierge moves up in the listing or line awaiting to be dispatched.

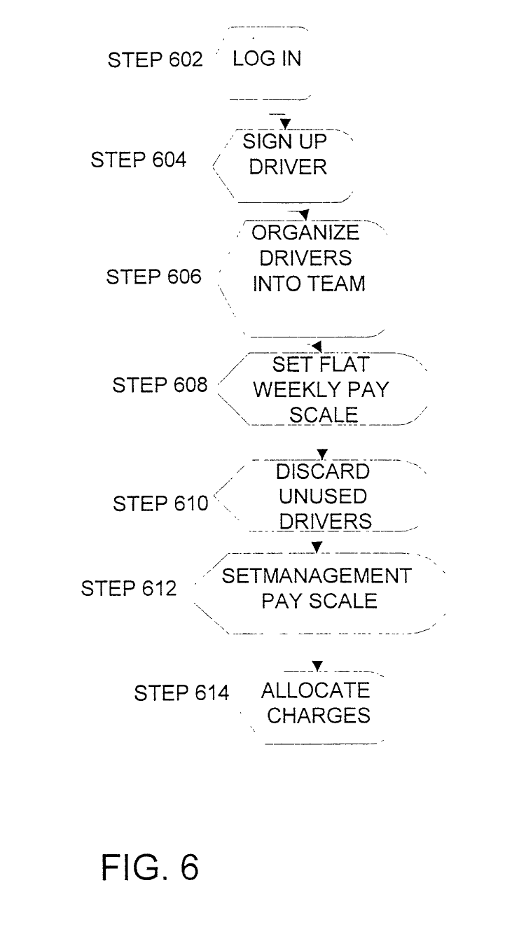

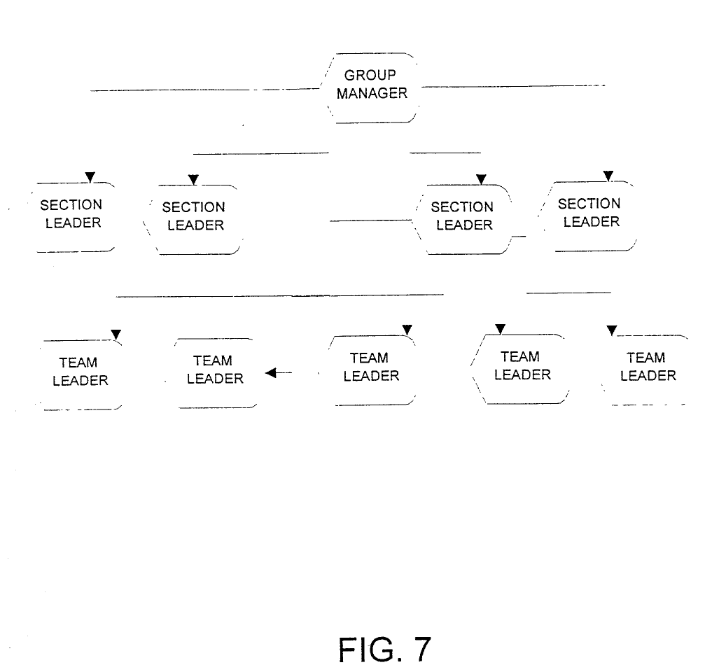

FIG. 6 is a flow chart showing a process for arranging drivers in a management team. With this design, a user such as a team leader, or section leader, or a group manager first attracts a driver to be a member of his or her team. The user can recruit this driver by offering a car to drive plus a potential commission for each trip taken. The user may require particular codes of conduct such as maintaining a late model car, adhering to a dress code and also acting in a professional manner such as being punctual, courteous, and professional in all dealings as each user such as a team leader recruits more drivers through the ranks from team leader to section leader to group manager. This hierarchy is shown in greater detail in FIG. 7.

For example, in step 602, the user logs into the system. In this step, if the user is a first time user, that user registers with the system. In step 606, the user organizes the drivers into teams. Next, in step 608, the system reviews and discards any inactive drivers from a list of drivers. This pares the list down to only a list of active drivers and users. Next, in step 610, the system sets a weekly pay scale based on the number of active users. Next, in step 612, the system sets a management pay scale based upon the performance of the drivers. Payment from this pay scale can be conducted on a weekly or a monthly basis. The system gives the car service company the advantage of a franchise typed business that allows car service companies to grow rapidly.

Accordingly, while several embodiments of the present invention have been shown and described, it is to be understood that many changes and modifications may be made thereunto without departing from the spirit and scope of the invention.

What is claimed is:

1. A computerized process for selecting a vehicle for transport comprising the following steps:
a) selecting a departure location;
b) selecting a destination location;
c) selecting a preferred carrier;
d) determining whether said preferred carrier is available;
e) selecting at least one additional carrier if said preferred it carrier is not available;
f) presenting said at least one additional carrier to a user;
and
g) processing a reservation.

2. The process as in claim 1, wherein said step of selecting at least one additional carrier is performed by said preferred carrier.

3. The process as in claim 2, further comprising the step of automatically determining a referral fee for said preferred carrier for referring a user to said at least one additional carrier.

4. The process as in claim 1, wherein said step of selecting said at least one additional carrier is performed automatically, based upon at least one of the following criteria: availability, price of the fare, and quality of service.

5. The process as in claim 2, further comprising the steps of receiving a fare from a user after said reservation has been completed, and forwarding a referral fee from said at least one additional carrier to said primary carrier once said fare has been received.
